(19) United States
(12) Patent Application Publication
(10) Pub. No.: US 2006/0088758 A1
(43) Pub. Date: Apr. 27, 2006

(54) Battery case for an electric bicycle and a mounting structure thereof

(76) Inventor: Yi-Chieh Wu, Taichung County (TW)

Correspondence Address: CHARLES E. BAXLEY, ESQ., 90 JOHN STREET, THIRD FLOOR, NEW YORK, NY, 10038, US

(21) Appl. No.: 11/091,815

(22) Filed: Mar. 28, 2005

(30) Foreign Application Priority Data
Oct. 22, 2004 (TW) 093132240

(51) Int. Cl. H01M 2/10; H01M 10/50

(52) U.S. Cl. 429/97; 429/100; 429/120

(57) ABSTRACT

A battery case for an electric bicycle and a mounting structure thereof is disposed at the handlebar of an electric bicycle. If the battery case is provided with battery indicator, speed indicator, headlight and the like instruments, the user rider can read it easily, and the battery case also can be used as a meter. Thus, not only the meter cost is saved, but also the circuit installation is simplified. Furthermore, the battery case is loaded on the flanges of the mounting base, and the connection between the battery case and the mounting base is strengthened by a projection and a locking cavity. Therefore, the battery case not only can be easily assembled and disassembled but also can be positioned firmly.

### BACKGROUND OF THE INVENTION

1. Field of the Invention

The present invention relates to a battery case for an electric bicycle and a mounting structure thereof, and more particularly to a design capable of enabling the battery case to be assembled to the handlebar of an electric bicycle easily and firmly.

2. Description of the Prior Arts

Along with the development of technology in battery industry, the battery, such as nicad battery, Ni-MH Battery, Li-ion battery and so on, is minimized substantially both in weight and size. Since it is rechargeable, the battery can be applied in the electronic products or the electronic bicycle.

The battery case for an electric bicycle is normally disposed on the frame beneath the rear seat, or on the saddle pillar. However, the battery case is normally provided with battery indicator, operation light and the like functions, so the rider is unable to read the indications on the battery case when the electric bicycle is running. To solve this problem, a control panel is assembled to the handle bar so that the user can read it easily. However, adding a control panel not only increases the cost, but also needs a circuit to be connected between the battery case and the control panel. Therefore, not only the appearance of the bicycle is spoiled, but also the circuit will cause extra problems.

Hence, if the battery case is disposed at the handlebar, then the energy level of the battery, the operation light and the like information is within the rider's line of sight.

The present invention has arisen to mitigate and/or obviate the afore-described disadvantages.

### SUMMARY OF THE INVENTION

The primary objective of the present invention is to provide a battery case for an electric bicycle and the mounting structure thereof. The battery case is disposed at the handlebar of an electric bicycle right within the rider's line of sight. If the battery case is provided with battery indicator, speed indicator, operation light, headlight and the like instruments, then the user rider can read it clearly, and the battery case also can be used as a meter. Thus, not only the meter cost is saved, but also the circuit installation is relatively simplified.

The secondary objective of the present invention is to provide a battery case for an electric bicycle and the mounting structure thereof. The weight of the battery case is transmitted to the flanges of the mounting base through the groove, and the connection between the battery case and the mounting base is strengthened by locking the projection of the locking assembly into the locking cavity. Therefore, the battery case not only can be easily assembled and disassembled but also can be positioned firmly.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an exploded view of a battery case for an electric bicycle and a mounting structure thereof in accordance with the present invention;

FIG. 2 is an assembly view of the battery case for the electric bicycle and the mounting structure thereof in accordance with the present invention;

FIG. 3 is an operational view of a battery case for the electric bicycle and the mounting structure thereof in accordance with the present invention;

FIG. 4 shows the status before the battery base is assembled to the mounting base;

FIG. 5 shows the battery base is being assembled to the mounting base, wherein the guide block contacts the projection of the follower;

FIG. 6 is a cross sectional assembly view of showing the battery case and the mounting base;

FIG. 7 is an operational view of showing how to disassemble the battery case from the mounting base;

FIG. 8 shows another embodiment of the present invention, wherein the mounting base is provided with ventilation fan.

### DETAILED DESCRIPTION OF THE PREFERRED EMBODIMENTS

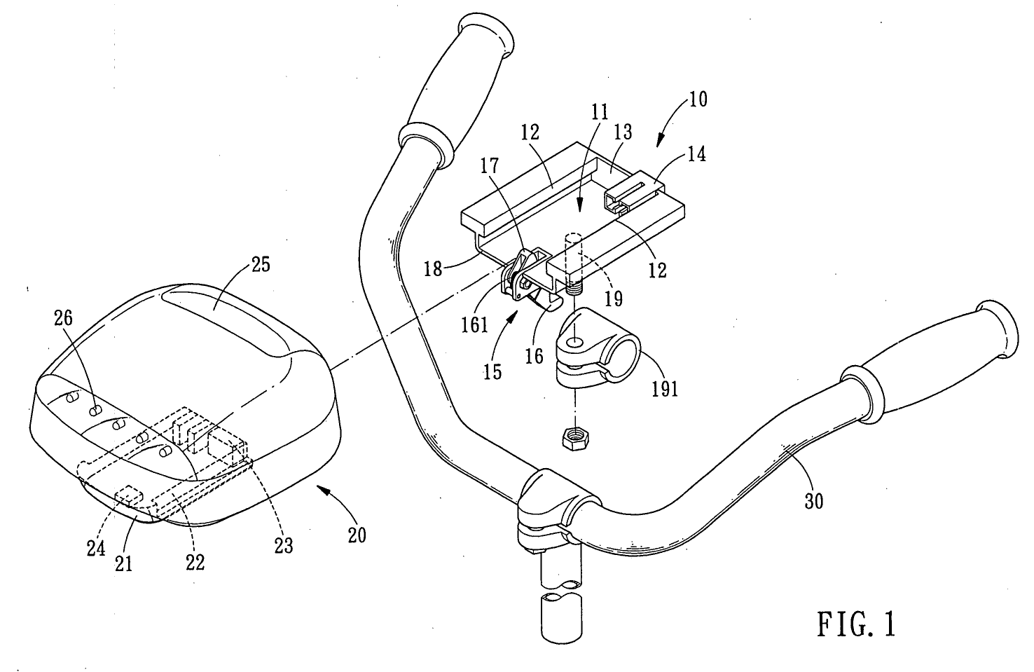

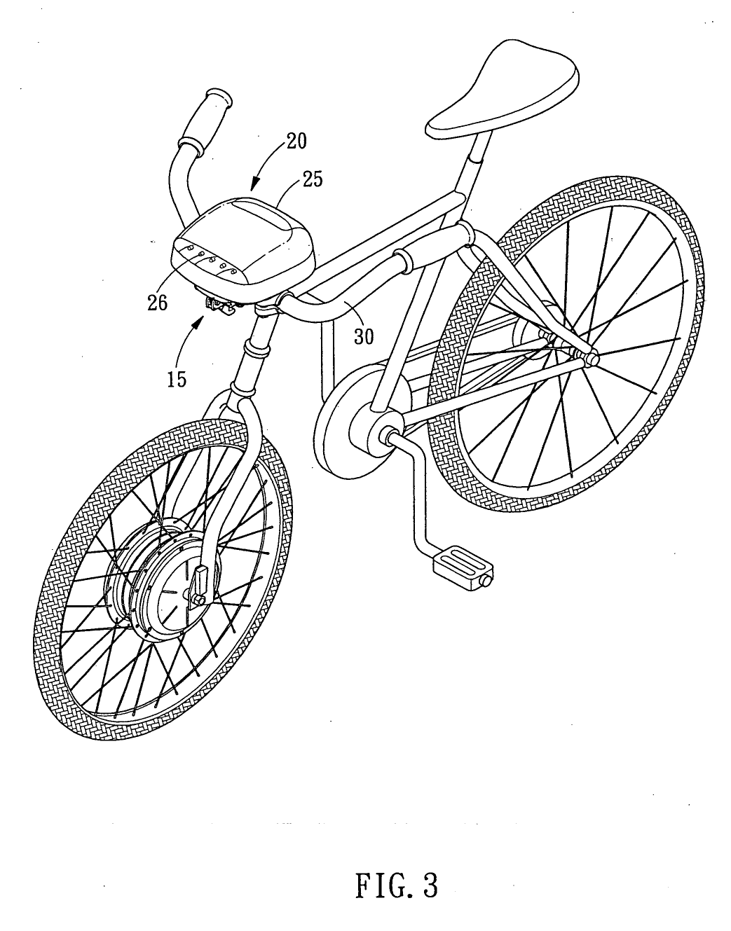

Referring to FIGS. 1-3, a battery case for an electric bicycle and a mounting structure thereof is shown and comprises a mounting base 10 and a battery case 20 mounted on a handlebar 30 of an electric bicycle.

The mounting base 10 is provided with a recess 11 having two flanges 12 located opposite each other. A terminal 14 is disposed at the rear sidewall 13 of the mounting base 10 and located between the two flanges 12. At the front gap of the recess 11 is a locking assembly 15 which can rotate a projection 17 by rotating a follower 16, so that the projection 17 will be enabled to move out of and back into the bottom surface 18 of the recess 11 according to needs. The follower 16 of the locking assembly 15 will return to its original position automatically through a spring 161. The mounting base 10 is fixed to the handlebar 30 of the electric bicycle through a clamp 191 and a bolt 19 extending from the bottom surface 18.

The battery case 20 is provided at its bottom surface with a guide block 21, at either side of the guide block 21 is formed a groove 22. A terminal 23 is disposed at an end surface of the guide block 21 and located between the grooves 22, at another end of the guide block 21 opposite the terminal 23 is a locking cavity 24. The two flanges 12 of the mounting base 10 are used to insert in the grooves 22 of the guide block 21 on the battery case 20, so that the projection 17 of the locking assembly 15 will be engaged in the locking cavity 24 of the guide block 21 after the guide block 21 of the battery case 20 is fully engaged in the recess 11 of the mounting base 10. Meanwhile, the terminal 14 of the mounting base 10 is also connected to the terminal 23 of the battery case 20. In addition, the battery case 20 further can be provided with display instrument 25 for indicating the energy level of the battery, the speed of the bicycle or the like information.

The above description is about the constructional relationship of the respective components, and the operation of the present invention will be explained as follows:

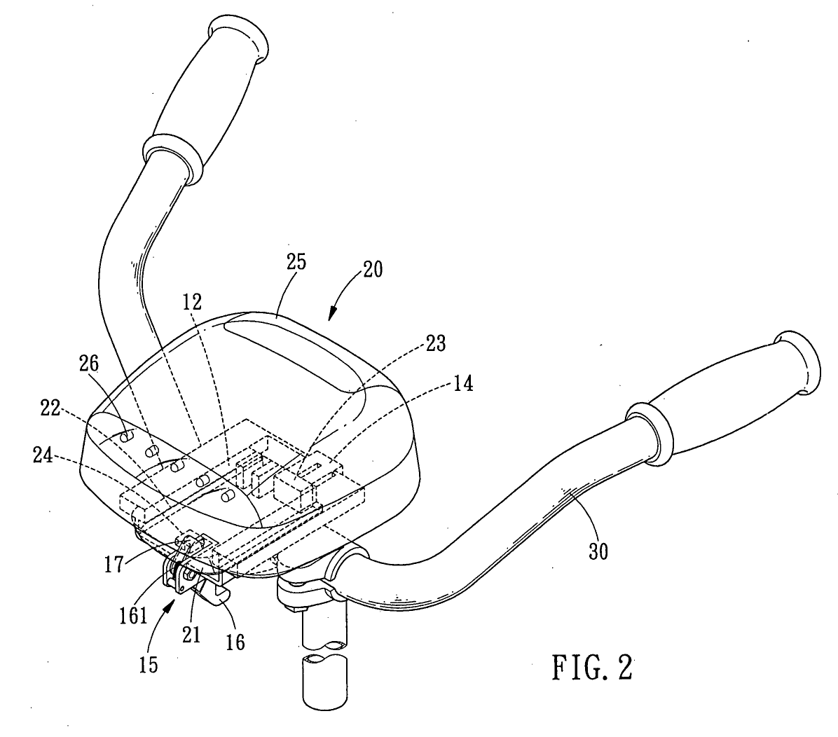

Referring again to FIGS. 1-2, to assemble the mounting base 10 to the handlebar 30, the user can fix the clamp 191 on the handlebar 30 first, and then inserts the bolt 19 on the mounting base 10 through the clamp 191 and locks it with a nut. By this method, the mounting base 10 is easily fixed.

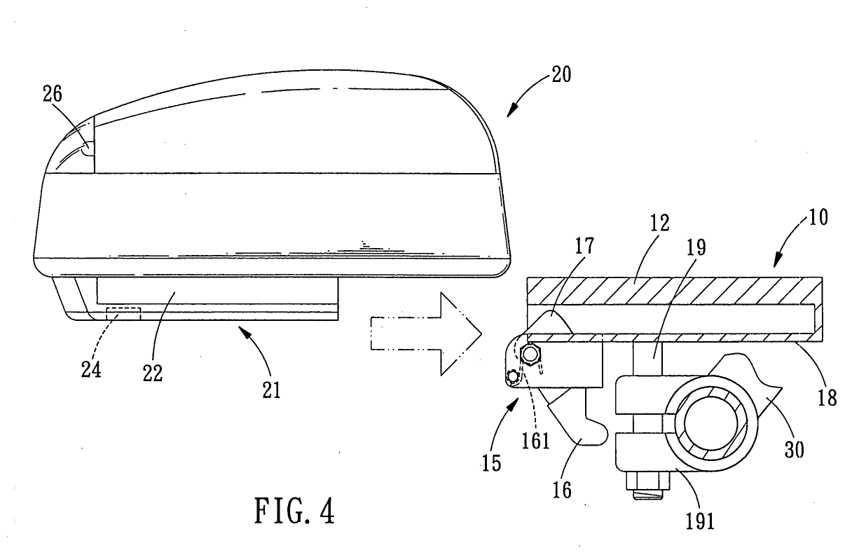

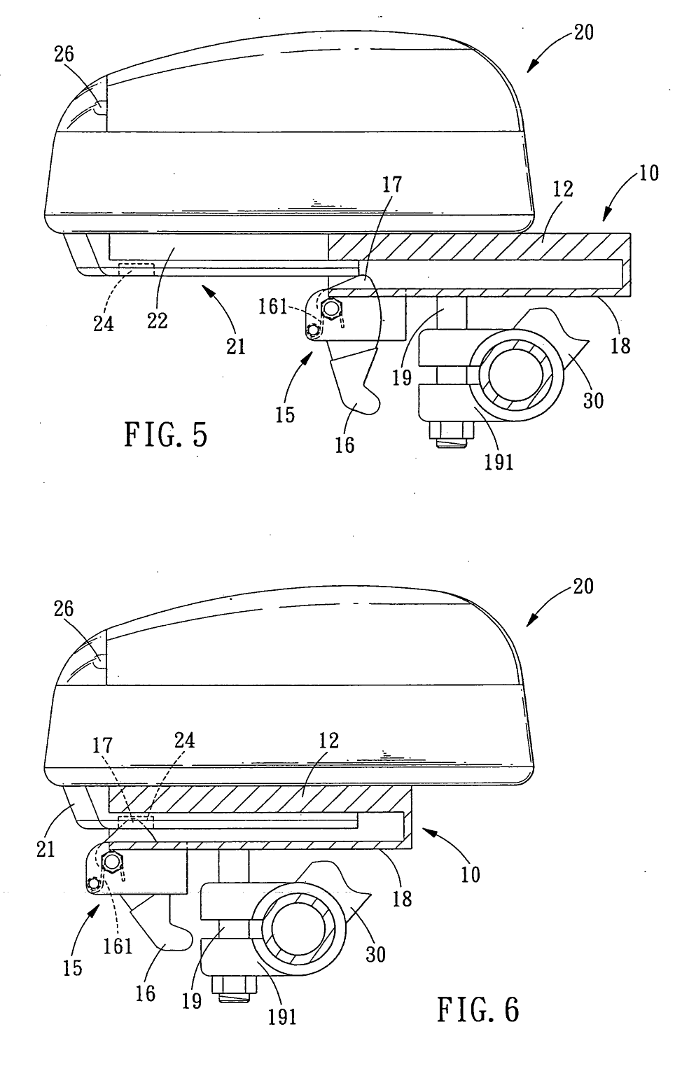

Referring further to FIGS. 4-6, to assemble the battery case 20 on the mounting base 10, the user can make the grooves 22 at both sides of the guide block 21 of the battery case 20 slideably engage with the two flanges 12 at both edges sides of the recess 11 of the mounting base 10, and then keep pushing the guide block 21 of the battery case 20 toward the recess 11 so that the projection 17 of the locking assembly 15 will be pushed into the bottom surface 18 of the recess 11 by the guide block 21 (as shown in FIG. 5). Once the battery case 20 is in place and fully engaged in the recess 11, the projection 17 of the recess 11 will be pushed out of the bottom surface 18 of the recess 11 and into the locking cavity 24 of the battery case by the spring 161 (as shown in FIG. 6). And meanwhile, the terminals 14, 23 are electrically connected to each other.

It is to be noted that vibrations are inevitable when the electric bicycle is running on uneven rod. However, the connection between the battery case 20 and the mounting base 10 is quite stable, since the weight of the battery case 20 is transmitted to the flanges 12 of the mounting base 10 through the grooves 22, and the connection between the battery case 20 and the mounting base 10 is strengthened by locking the projection 17 of the locking assembly 15 into the locking cavity 24. Therefore, the battery case 20 can be positioned firmly.

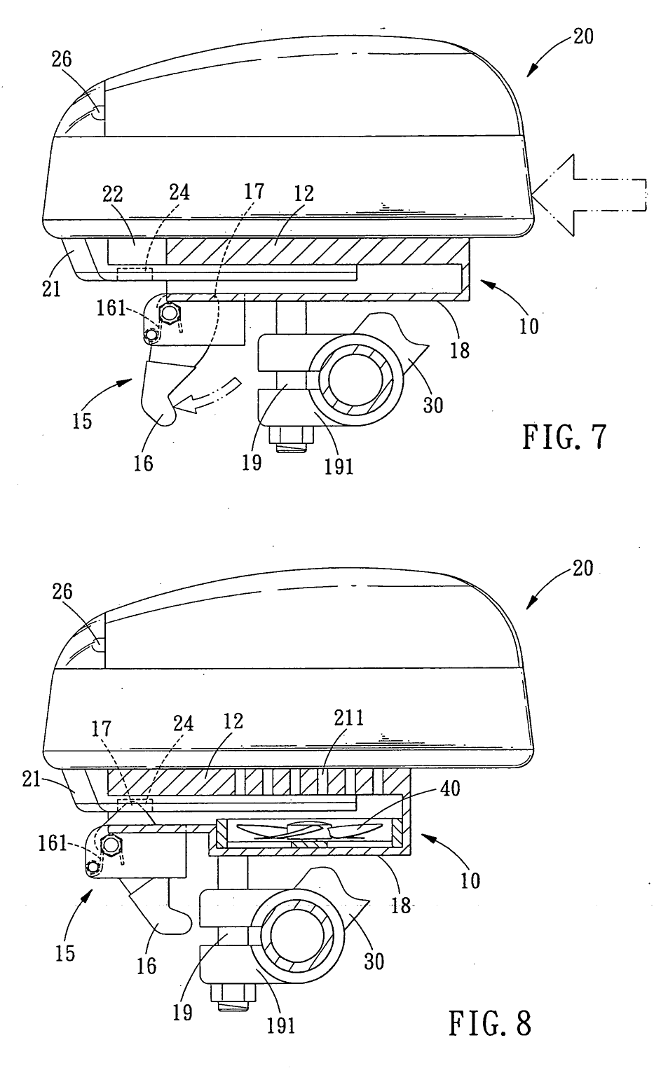

In addition, the battery case 20 can be disassembled easily from the mounting base 10 by pulling the follower 16 of the locking assembly 15 to disengage the projection 17 from the locking cavity 24 (as shown FIG. 7), and then pushing the grooves 22 of the battery case 20 out of the flanges 12 of the mounting base 10.

It is to be noted that the battery case 20 is disposed on the handlebar 30 within the rider's line of sight. If the battery case 20 is provided with battery indicator, speed indicator, operation light, and the like instruments 25, then the user rider can read it clearly. Furthermore, as shown in FIG. 2, the battery case 20 also can be provided with a headlight 26 and other devices, like switch, button, so that the battery case also can serve as a meter. Thus, not only the meter cost is saved, but also the circuit installation is relatively simplified.

On the other hand, to have an improved heat-dissipating effect when the battery is in use, a fan 40 is disposed in the recess 11 of the mounting base 10 (as shown in FIG. 8) and electrically connected to terminal 14. On the guide block 21 are defined a plurality of air orifices 211, so that the fan 40 gets power from the battery base 20 through the terminals 14, 23 to exhaust heat out of the battery case 20 via the air orifices 211.

While we have shown and described various embodiments in accordance with the present invention, it should be clear to those skilled in the art that further embodiments may be made without departing from the scope of the present invention.

What is claimed is:

1. A battery case for an electric bicycle and a mounting structure thereof comprising:
a mounting base provided with a recess having two flanges located opposite each other, a terminal disposed at a rear sidewall of the mounting base and located between the two flanges, at a front gap of the recess formed a locking assembly which being able to rotate a projection by rotating a follower, the mounting base being fixed to handlebar of an electric bicycle through a bolt extending from the bottom surface;
a battery case provided at its bottom surface with a guide block, at either side of the guide block formed a groove, a terminal disposed at an end surface of the guide block and located between the grooves, at another end of the guide block opposite the terminal formed a locking cavity, the two flanges of the mounting base slidably engaged in the grooves of the battery case, wherein the projection of the locking assembly will be engaged in the locking cavity of the guide block after the guide block of the battery case is fully engaged in the recess of the mounting base, meanwhile, the terminal of the mounting base is electrically connected to the terminal of the battery case.

2. The battery case for an electric bicycle and the mounting structure thereof as claimed in claim 1, wherein the mounting base is mounted to the handlebar by fixing a clamp on the handlebar first, and then inserting the bolt of the mounting base through the clamp and locking the blot with a nut.

3. The battery case for an electric bicycle and the mounting structure thereof as claimed in claim 1, wherein a fan is disposed in the recess of the mounting base and electrically connected to the terminal of the mounting base, and on the guide block are defined a plurality of air orifices, so that the fan gets power from the battery base to exhaust heat out of the battery case via the air orifices.

4. The battery case for an electric bicycle and the mounting structure thereof as claimed in claim 1, wherein a display instrument is provided on the battery case for indicating condition of the electric bike.
